(19) United States
(12) Patent Application Publication
(10) Pub. No.: US 2026/0230287 A1
(43) Pub. Date: Aug. 6, 2026

(54) Determining Known and Unknown TCI State With AI Predicted Beam

(71) Applicant: Apple Inc., Cupertino, CA (US)

(72) Inventors: Huaning NIU, San Jose, CA (US); Konstantinos SARRIGEORGIDIS, Los Gatos, CA (US); Manasa RAGHAVAN, Sunnyvale, CA (US); Wei ZENG, Saratoga, CA (US); Weidong YANG, San Diego, CA (US); Yang TANG, San Jose, CA (US)

(21) Appl. No.: 19/179,177

(22) Filed: Apr. 15, 2025

(30) Foreign Application Priority Data
Feb. 5, 2025 (GR) 20250100087

(51) Int. Cl. H04L 5/00; H04B 7/06; H04B 17/391

(52) U.S. Cl. CPC H04L 5/0091; H04B 7/06952; H04B 17/3913; H04L 5/0048

(57) ABSTRACT

An apparatus configured to measure, based on signaling from a network, a first set of reference signals (RS) for a first set of beams, generate, for transmission to the network, a measurement report corresponding to the first set of beams, wherein second measurements for a second set of beams are predicted from first measurements of the first set of RS and process, based on signaling from the network, a command to switch an active transmission configuration indicator (TCI) state to a target TCI state associated with the second set of beams, the target TCI state having a known condition when the apparatus supports a capability for determining a best receive (Rx) beam to use for the second set of beams, the target TCI state having an unknown condition when the apparatus does not support the capability.

### BACKGROUND

Artificial intelligence (AI) and/or machine learning (ML) processes, e.g., deep learning neural networks, may be used to augment operations for the air interface in a cellular radio access network (RAN), e.g., 5G New Radio (NR) RAN, 6G RAN, etc. The use cases of AI/ML for the air interface include beam management (BM).

### SUMMARY

Some example embodiments are related to an apparatus having processing circuitry configured to measure, based on signaling from a network, a first set of reference signals (RS) for a first set of beams, generate, for transmission to the network, a measurement report corresponding to the first set of beams, wherein second measurements for a second set of beams are predicted from first measurements of the first set of RS and process, based on signaling from the network, a command to switch an active transmission configuration indicator (TCI) state to a target TCI state associated with the second set of beams, the target TCI state having a known condition when the apparatus supports a capability for determining a best receive (Rx) beam to use for the second set of beams, the target TCI state having an unknown condition when the apparatus does not support the capability.

Other example embodiments are related to an apparatus having processing circuitry configured to process, based on signaling from a network, one or more quasi-co-location (QCL) relationships between a first set of reference signal (RS) for a first set of beams and a second set of RS for a second set of beams, measure, based on signaling from a network, the first set of RS for the first set of beams, generate, for transmission to the network, a measurement report corresponding to the first set of beams, wherein second measurements for a second set of beams are predicted from first measurements of the first set of RS and process, based on signaling from the network, a command to switch an active transmission configuration indicator (TCI) state to a target TCI state associated with the second set of beams, the target TCI state having a known condition when the target TCI state is based on RS from the second set of beams with a QCL relationship configured to RS from the first set of beams.

Still further example embodiments are related to an apparatus having processing circuitry configured to measure, based on signaling from a network, a first set of reference signal (RS) for a first set of beams, generate, for transmission to the network, a measurement report corresponding to the first set of beams, wherein second measurements for a second set of beams are predicted from first measurements of the first set of RS and process, based on signaling from the network, a command to switch an active transmission configuration indicator (TCI) state to a target TCI state associated with the second set of beams, the target TCI state having an unknown condition when the apparatus supports a capability for using a fixed or beam for measuring the second set of beams.

Additional example embodiments are related to an apparatus having processing circuitry configured to measure, based on signaling from a network, a first set of reference signal (RS) for a first set of beams, generate, for transmission to the network, a measurement report corresponding to the first set of beams, wherein second measurements for a second set of beams are predicted from first measurements of the first set of RS and process, based on signaling from the network, a command to switch an active transmission configuration indicator (TCI) state to a target TCI state associated with the second set of beams, the target TCI state having a known condition when the apparatus supports a capability for determining a fixed receive (Rx) beam to use for the second set of beams based on measurements acquired during a P2 beam management procedure.

Further example embodiments are related to an apparatus having processing circuitry configured to measure, based on signaling from a network, a first set of reference signals (RS) from a first set of beams, predict, from a first set of reference signal measurements for the first set of RS, second reference signal measurements for a second set of beams, generate, for transmission to the network, a measurement report corresponding to the second set of beams and process, based on signaling from the network, a command to switch an active transmission configuration indicator (TCI) state to a target TCI state associated with the second set of beams, the target TCI state having a known condition when the apparatus supports a capability for determining a receive (Rx) beam to use for the second set of beams and further supports a functionality for determining the Rx beam to use for the second set of beams based on an association identifier (ID) between the first set of beams and the second set of beams.

More example embodiments are related to an apparatus having processing circuitry configured to measure, based on signaling from a network, a first set of reference signals (RS) from a first set of beams, predict, from a first set of reference signal measurements for the first set of RS, second reference signal measurements for a second set of beams, generate, for transmission to the network, a measurement report corresponding to the second set of beams and process, based on signaling from the network, a command to switch an active transmission configuration indicator (TCI) state to a target TCI state associated with the second set of beams, the target TCI state having a known condition when the apparatus previously processed, based on signaling from the network, one or more quasi-co-location (QCL) relationships between the first set of RS and the second set of RS.

### BRIEF DESCRIPTION OF THE DRAWINGS

FIG. 1 shows a signaling diagram for a transmission configuration indicator (TCI) state switch according to various example embodiments.

FIG. 2 shows a signaling diagram for AI/ML based UE-side prediction for beam management according to various example embodiments.

FIG. 3 shows a signaling diagram for AI/ML based network-side prediction for beam management according to various example embodiments.

FIG. 4 shows a diagram for a first Tx beam pattern according to various example embodiments.

FIG. 5 shows a diagram for a second Tx beam pattern according to various example embodiments.

FIG. 6 shows a signaling diagram for UE capability and adaptability signaling for AI/ML beam management according to various example embodiments.

FIG. 7 shows an example network arrangement according to various example embodiments.

FIG. 8 shows an example UE according to various example embodiments.

FIG. 9 shows an example base station according to various example embodiments.

### DETAILED DESCRIPTION

The example embodiments may be further understood with reference to the following description and the related appended drawings, wherein like elements are provided with the same reference numerals. The example embodiments relate to transmission configuration indicator (TCI) state switching operations for scenarios in which artificial intelligence and/or machine learning (AI/ML) is employed for beam management (BM). In particular, the example embodiments relate to definitions of the known condition and the unknown condition for a target transmission configuration indicator (TCI) state when the target TCI state is based on a predicted beam (e.g., spatial prediction or temporal prediction) that was not directly measured prior to a TCI state switch.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange signaling and/or data with the network. Therefore, the UE as described herein is used to represent any electronic component.

The example embodiments are also described with reference to a 5G New Radio (NR) network. However, reference to a 5G NR network is merely provided for illustrative purposes. The example embodiments may be utilized with any network implementing AI/ML beam management functionalities similar to those described herein, e.g., 5G-Advanced network, 6G network, etc. Therefore, the 5G NR network as described herein may represent any type of network implementing AI/ML beam management functionalities similar to the 5G NR network.

The example embodiments are also described with regard to radio resource management (RRM), in particular, beam management (BM). Beam management generally refers to a set of procedures configured to acquire and maintain a beam between a base station or TRP and a UE. The terms P1, P2 and P3 refer to processes for beam management during initial access and while in the CONNECTED state. In the P1 process, the base station (e.g., gNB) performs Tx beam sweeping of synchronization signal blocks (SSBs), typically from a set of different beams, and the UE performs reception (Rx) wide beam sweeping from a set of different beams. The UE measures the signal strength (e.g., Reference Signal Received Power (RSRP)) of each of the SSBs of the received beams and selects the best beam to report to the gNB. In the P2 process, the gNB performs beam refinement by performing Tx beam sweeping of Channel State Information-Reference Signal (CSI-RS), possibly from a smaller set of beams than the P1 process, and the UE performs Rx wide beam sweeping from a set of different beams. The P2 Tx beam sweeping may be narrower than that of P1. The UE measures the signal strength (e.g., RSRP) of the CSI-RS of the received beams and selects the best beam to report to the gNB. In the P3 process the gNB (TRP) repeatedly transmits the same beam and the UE refines its Rx beam.

The example embodiments are also described with regard to transmission configuration indicator (TCI) states. A TCI state contains parameters for configuring a quasi co-location (QCL) relationship between one or more reference signals (RS) and corresponding antenna ports. A reference signal is considered to be QCLed to another reference signal if it is in the same TCI chain as the other reference signal. A UE may be configured by radio resource control (RRC) signaling with a list of up to M TCI state configurations. A TCI state from the configured list may be activated/deactivated for the UE by a medium access layer (MAC) control element (CE), a DCI message, or a RRC activation command. A TCI state according to the unified TCI framework configures both downlink (DL) and uplink (UL) transmissions simultaneously. In other words, a single TCI value or index indicates a specific combination of DL beamforming parameters used by the gNB for DL transmissions and UL beamforming parameters used by the UE for UL transmission. The TCI state may be used when the DL and UL channels are sufficiently similar. A DL TCI state configures only the DL transmission and a UL TCI state configures only the UL transmission, which may be used when the DL and UL channels are sufficiently different.

QCL type D relates to spatial Rx parameters to support beamforming and is used in beam management. The UE may derive the Rx beam based on a QCL type D relationship between different RS. In one example, an SSB may be the root source RS and a CSI-RS may be QCLed to the SSB. The UE may perform Rx beamsweeping to receive the SSB and find the best Rx beam (e.g., in the P1 procedure) and may then use the same Rx beam for CSI-RS reception (e.g., in the P2 procedure and/or for data transmissions).

A UE configured with one or more TCI state configurations on a serving cell may complete the switch of the active TCI state within a switching delay defined in 3GPP Technical Specification (TS) 38.133 section 8.10 (for the unified TCI state); 3GPP TS 38.133 section 8.15 (for the DL TCI state); and 3GPP TS 38.133 section 8.16 (for the UL TCI state). The target TCI state may be “known” or “unknown” to the UE as defined in 3GPP TS 38.133 section 8.10.2; 8.15.2; and 8.16.2. A known TCI state refers to a target TCI state to which the UE may switch without making further measurements for Rx beam refinement, such that the TCI state switching delay permitted for the UE when the TCI state is known is generally less than the TCI state switching delay permitted for the UE when the TCI state is unknown. The duration for the switching delay further depends on whether the TCI state switch command is by MAC-CE, DCI, or RRC.

The target TCI state is considered known by the UE if a set of conditions are met within a period spanning from a last transmission of the RS resource used for the Layer 1 Received Signal Reference Power (L1-RSRP) measurement reporting for the target TCI state to the completion of the active TCI state switch, where the RS resource for L1-RSRP measurement is the RS in the target TCI state or is QCLed to the target TCI state, as defined in 3GPP TS 38.133 section 8.10.2. A first condition comprises the TCI state switch command to the target TCI state is received within 1280 ms upon the last transmission of the RS resource for beam reporting or measurement. A second condition comprises the UE has sent at least one L1-RSRP report for the target TCI state before the TCI state switch command. A third condition comprises the TCI state remains detectable during the TCI state switching period. A fourth condition comprises the SSB associated with the TCI state remain detectable during the TCI switching period, with the SNR of the TCI state ≥−3 dB. Otherwise, the TCI state is unknown. The conditions for the DL TCI state and UL TCI state, as defined in 3GPP TS 38.133 sections 8.15.2 and 8.16.2, are similar to those for the TCI state as defined in 8.10.2.

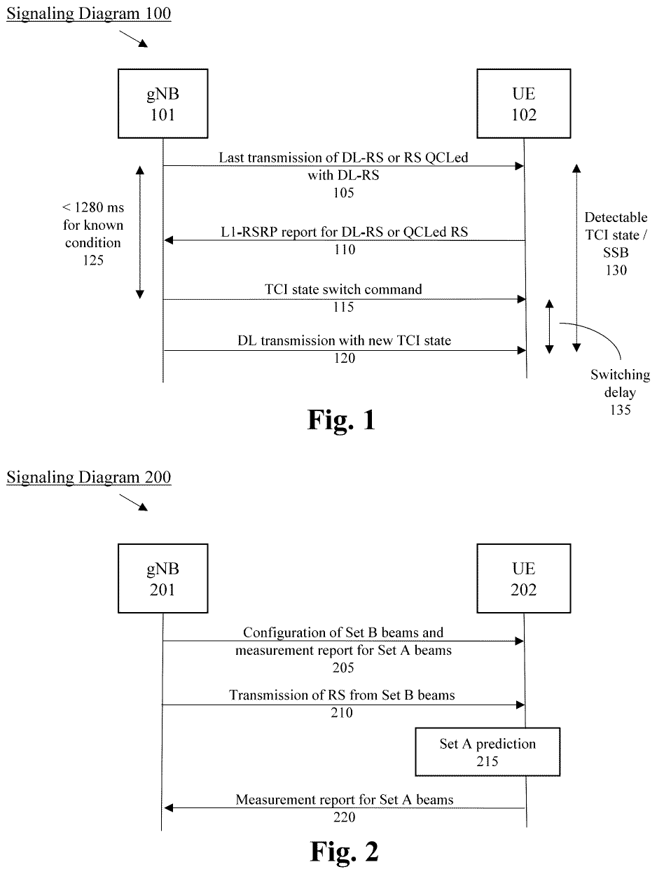

FIG. 1 shows a signaling diagram 100 for a transmission configuration indicator (TCI) state switch according to one example. The diagram 100 includes a gNB 101 and a UE 102 and is described with regard to the known condition for the TCI state switch.

In 105, a DL-RS of the target TCI state, or RS QCLed with DL-RS of the target TCI state, is transmitted by the gNB 101 and measured by the UE 102. In 110, a L1-RSRP measurement report is transmitted by the UE 102 to the gNB 101. The measurement report includes measurements for the DL-RS of the target TCI state, or the RS QCLed with DL-RS of the target TCI state, that was measured in 105.

In 115, a TCI state switch command is transmitted by the gNB 101 to the UE 102. The TCI state switch command indicates the target TCI state. The UE 102 is expected to complete the switch within a switching delay 135 that may be defined based in part on whether the target TCI state is known or unknown. In 120, a DL transmission with the new TCI state is transmitted by the gNB 101 to the UE 102.

The target TCI state is known by the UE 102 if: the duration 125 from the last transmission of RS of 105 to the TCI state switch command of 115 is <1280 ms; if the L1-RSRP report of 110 is transmitted between the last RS transmission of 105 and the TCI state switch command of 115; and if the target TCI state and SSB remain detectable for the duration 130 of the TCI state switch (from the last transmission of RS of 105 through the DL transmission of 120). Otherwise the target TCI state is unknown. In general, if the target TCI state is unknown, a longer duration is allotted for the switching delay to permit the UE 102 to perform beam refinement. After the switching delay 135, the UE is expected to be able to receive on the DL with the target TCI state.

The example embodiments are also described with regard to AI/ML-based radio resource management (RRM), in particular, AI/ML-based beam management (BM). An AI/ML model may be employed for beam prediction to reduce overhead/latency and improve beam selection. The AI/ML model may be employed for beam prediction in the time domain and/or the spatial domain. In both cases, a set of downlink beams may be measured and used as input to the AI/ML model to predict the best beam within another set of downlink beams. In some example embodiments, the measured parameter/quantity may be L1-RSRP. However, the example embodiments are not limited to this parameter. The measured set of downlink beams may be referred to as “Set B” and the predicted set of downlink beams may be referred to as “Set A.” Set B may be a subset of Set A, or Set B may be different from Set A. For example, the base station may be capable of transmitting 64 beams but the base station may transmit only 4 beams or 8 beams as the Set B of beams. The AI/ML model may then predict a larger set of beams, e.g., the Set A of beams.

The input into the AI/ML model may be measurement results based on measurements performed by the UE on the Set B of beams. The inputs may also include other inputs such as beam forming assumptions and configuration assumptions used by a base station to transmit the Set B of beams. The AI/ML model uses these inputs to predict a beam report for a Set A of beams, which may include a best beam from the Set A and/or L1-RSRP. The AI/ML model may reside at the UE or at the network (e.g., base station).

For UE-side beam prediction, the beam report may include, for example, beam indices for the Set A of beams, Reference Signal Received Power (RSRP) for the Set A of beams, etc. The beam report for the set A of beams is not based on actual measurements on the set A of beams but is based on a prediction by the AI/ML model using the inputs. The report may include the top K beam measurements (predictions) along with the beam index or may include only the top K beam indices. The network may then use the information from the beam report to perform BM operations in the downlink (DL) such as changing a TCI state for DL transmissions. The AI/ML model may be trained using any data and/or technique and the training of the AI/ML model is beyond the scope of this disclosure.

FIG. 2 shows a signaling diagram 200 for AI/ML based UE-side prediction for beam management according to one example. The diagram 200 includes a gNB 201 and a UE 202. In 205, the gNB 201 configures the UE 202 with Set B beams and a measurement report for Set A beams. In 210, the gNB 201 transmits RS from the Set B beams for measurement by the UE 202. In 215, the UE 202 predicts the Set A beams. In 220, the UE 202 transmits a measurement report corresponding to the Set A beams.

For network-side beam prediction, the beam report from the UE may include Set B measurements, e.g., RSRP and/or beam indices for the Set B of beams, so that the network may perform the prediction for the Set A of beams. The network may then use the information from the beam report to perform BM operations in the downlink (DL), similar to above.

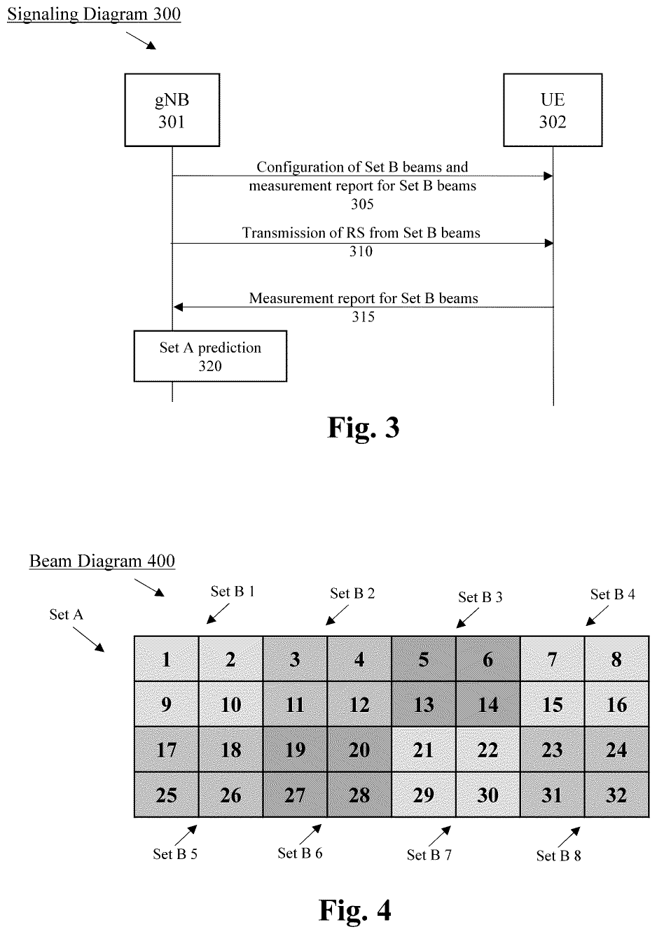

FIG. 3 shows a signaling diagram 300 for AI/ML based network-side prediction for beam management according to one example. The diagram 300 includes a gNB 301 and a UE 302. In 305, the gNB 301 configures the UE 302 with Set B beams and a measurement report for the Set B beams. In 310, the gNB 301 transmits RS from the Set B beams for measurement by the UE 302. In 315, the UE 302 transmits a measurement report corresponding to the Set B beams. In 320, the gNB 301 predicts the Set A beams based on the measurement report.

It is noted that FIGS. 2-3 discussed above relate to an inference phase of the AI model. Prior to the inference phase, the UE and the gNB may perform a data collaboration procedure in which training data is generated for training the AI model. For the UE-side model, the network may transmit the Set A beams and the Set B beams in a beam sweeping procedure and the UE may measure the beams to generate the training data for training the UE-side model. For the network-side model, the network may transmit at least the Set B beams and, in some cases, may transmit the Set A beams. The UE may measure the beams and report the measurements to the network so that the network may generate the training data for training the network-side model.

For BM-Case1 and BM-Case2 with a UE-side AI/ML model, the network may indicate the Set A associated with Set B, e.g., an association/mapping of beams within Set A and beams within Set B if applicable. It is not settled whether the beam indication from the network will have additional specification impact (e.g., legacy mechanism may be reused), particularly, how to perform beam indication of beams in Set A not in Set B. At least for BM-Case1 with a UE-side AI/ML mode, the legacy TCI state mechanism may be used to perform beam indication of beams. For DL beam pair prediction, there is no consensus to support the reporting of the predicted Rx beam(s) (e.g., Rx beam ID, Rx beam angle information, etc.) from the UE to the network.

There are ongoing discussions regarding whether the TCI state associated with a predicted Tx beam is known or unknown, in particular, whether the UE Rx beam may be considered known or unknown. In one proposal, the UE Rx beam is always known. This proposal requires the UE Rx beam gain to be considered when making the prediction. In another proposal, the UE Rx beam is always unknown. In other proposals, the UE Rx beam knowledge depends on some conditions and/or depends on UE capability. These proposals are left for further study.

According to various example embodiments described herein, operations are described for determining the known and unknown TCI state when a target TCI state is a predicted beam. Some example embodiments relate to a network-side model, wherein the known and unknown TCI states depend on the Set A and Set B beam patterns used by the network for the Tx beam and different methods used by the UE for determining the Rx beam during training/inference. Other example embodiments relate to a UE-side model, wherein the known and unknown TCI states depend on whether the UE Rx beam is predicted or not, with UE capability and potential UE feedback on the QCL source RS.

In some aspects of the example embodiments, the known/unknown TCI state may be determined for a network-side model in view of network-side beam assumptions and UE-side beam assumptions.

For AI/ML based BM for a network-side model in Rel-18, two different types of set B beam patterns are evaluated for the Tx beam. In a first case, the Set B beams are wide beams and cover set A beams, similar to non-AI based beam management where SSB is sent in wide beams corresponding to the set B beams, and CSI-RS and data transmissions are sent in narrow beams corresponding to the set A beams. In a second case, the Set B beam is a sub-set of set A beams, e.g., a down-sampled version of the Set B beams.

FIG. 4 shows a diagram 400 for a Tx beam pattern according to one example. In this example, there are 32 Set A beams corresponding to beam indices 1-32 in the diagram 400 and 8 Set B beams, each Set B beam covering four Set A beams, e.g., Set B beam 1 covers Set A beams {1-2, 9-10}; Set B beam 2 covers Set A beams {3-4, 11-12}; Set B beam 3 covers Set A beams {5-6, 13-14}; Set B beam 4 covers Set A beams {7-8, 15-16}; Set B beam 5 covers Set A beams {17-18, 25-26}; Set B beam 6 covers Set A beams {19-20, 27-28}; Set B beam 7 covers Set A beams {21-22, 29-30}; and Set B beam 8 covers Set A beams {23-24, 31-32}. In this example, the root RS may be easily identified, e.g., fine beams 1, 2, 9, 10 of Set A are QCL type D to wide beam 1 of set B beam.

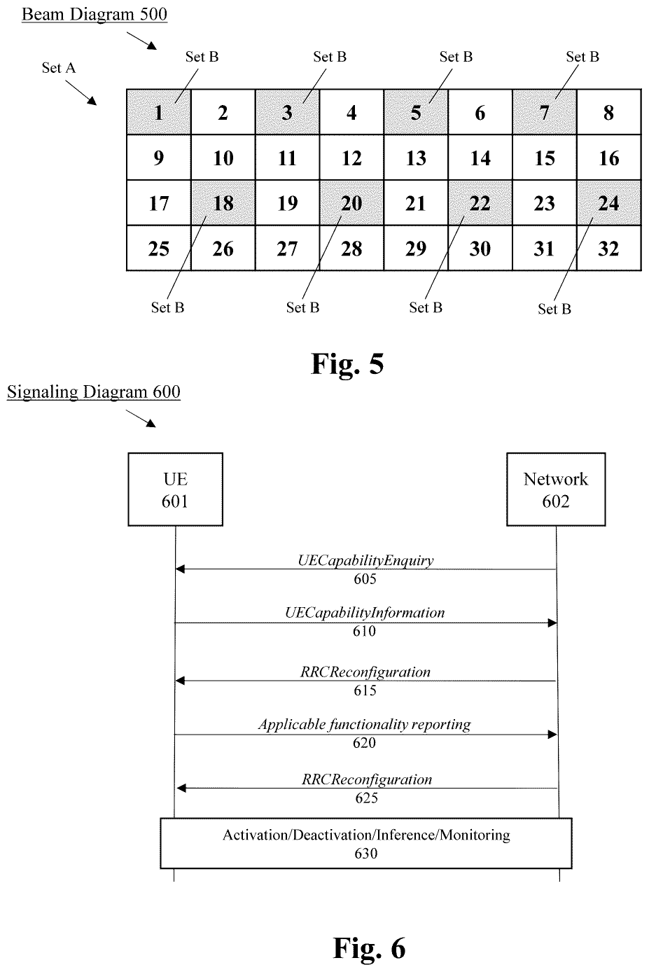

FIG. 5 shows a diagram 500 for a Tx beam pattern according to another example. In this example, there are 32 Set A beams corresponding to beam indices 1-32 in the diagram 500 and 8 Set B beams, the Set B beams comprising a subset of the Set A beams. In this example, the Set B beams comprise beam indices {1, 3, 5, 7, 18, 20, 22, 24). There is some ambiguity of root RS for QCL type D, for example, it is hard to tell whether beam 10 is QCL to beam 1 or beam 18 of set B.

For the network-side model, different assumptions may apply regarding the UE-side Rx beam. Depending on the network-side beam pattern (as described above), and the following four cases for UE-side Rx beam implementation, different combinations of the known and unknown TCI state may be implemented.

In a first case, the UE always uses the best Rx beam to measure Set B beams and Set A beams and the corresponding L1-RSRP. The UE may determine the best Rx beam for Set B beams and Set A beams during a data collaboration procedure for generating training data for the network-side AI model.

In the data collaboration procedure, the network may sweep beams from both Set A and Set B for measurement at the UE side and reporting to the network. In training data collection for a network-side model based on a minimization of drive test (MDT) framework, the UE reports the Tx beam with corresponding L1-RSRP with the best UE Rx beam for both Set A and Set B. During inference, the UE reports the L1-RSRP and corresponding Tx beam index(es) (CRI/SSBRI) assuming the best UE Rx beam. It is noted that the UE method for determining the best Rx beam is requires advanced UE-side Rx beam management techniques. In one example, the UE may record the best Rx beam in global coordinates during training. During inference, based on sensor information and UE orientation, the UE may figure out the best Rx beam to use for the set A. During performance monitoring, the best Rx beam for set A and set B respectively is used.

According to some example embodiments, a UE capability is defined for UE support of determining the best Rx beam to use for a TCI state switch to a predicted beam, e.g., according to the first case discussed above. In one embodiment, if the UE supports this capability and reports the capability to the network, then the TCI state is always known. The network may assume that the UE is able to determine the best Rx beam for any TCI state switch to a Set A beam. In another embodiment, if the UE does not support this capability, then the TCI state is always unknown.

In a second case, the UE always uses the best Rx beam for set B measurement, and UE uses the best Rx beam of set B for set A measurement during training and inferencing. The UE may determine the best Rx beam for Set B beams during a data collaboration procedure for generating training data for the network-side AI model; during inferencing; or during performance monitoring. In this case, the UE needs to know the root RS of the Set A configuration with respect to set B RS. Accordingly, the network may signal this information to the UE.

In the data collaboration procedure, the network may sweep beams from Set B for measurement at the UE side and reporting to the network. In addition, using data collection for training procedure, the gNB may indicate the root RS of set A configuration with respect to set B RS used by the gNB. In training data collection for the network-side model based on MDT framework, the UE reports the Tx beam with corresponding L1-RSRP with best UE Rx beam for set B and set A L1-RSRP with best UE Rx beam QCLed to set B beam. During inference, the UE reports the Set B L1-RSRP and corresponding NW beam index (CRI/SSBRI, may be more than 4) assuming the best UE Rx beam for set B. In the inference phase, the same QCL type D root RS to set B may be signaled by the network, similar to the training phase.

According to some example embodiments, the UE determines the best Rx beam for Set B measurements and uses the best Rx beam for Set A in a TCI state switch based on a QCL relationship signaling from the network, e.g., according to the second case discussed above for UE beam implementation for a network-side model. When the gNB signals the QCL relationship between set A and set B, in training RS configuration, inference RS configuration and/or performance monitoring RS configuration, the TCI state is considered known when the following conditions are met: the target TCI state is based on RS from set A beams with QCL relationship configured to a set B beam; the time between TCI state switch command and transmission of the QCLed RS from set B shall not exceed X ms (X=1280 ms (legacy)); the UE shall send measurement report for the QCLed RS from Set B between transmission and TCI state switch; and the TCI state and SSB of TCI state remain detectable during TCI state switching period. Otherwise, the TCI state is unknown.

In a third case, the UE always uses a fixed Rx beam to measure set B beams and set A beams and the corresponding L1-RSRP. The fixed Rx beam may be for example, a quasi-omni Rx beam. In training data collection for the network-side model based on MDT framework, the UE report the gNB beam with corresponding L1-RSRP with the fixed UE Rx beam. During inference, the UE reports the L1-RSRP and corresponding NW beam index (CRI/SSBRI, may be more than 4) assuming the fixed UE Rx beam.

According to some example embodiments, a UE capability is defined for the use of fixed or random Rx beam during training and inference, e.g., according to the third case discussed above for UE beam implementation for a network-side model. In these embodiments, if the UE reports the capability of using fixed/random beam for AI based beam prediction with network-side model, the TCI state is always unknown.

In a fourth case, when set B measurement is part of P2 procedure, the UE determines a Rx beam for a Set A beam during the P2 procedure and uses this fixed Rx beam in a TCI state switch to the Set A beam. In this case, the P1 procedure may follow legacy beam sweeping and the UE Rx beam for a Set A beam may be obtained in a P2 RS measurement. This Set A beam may subsequently be predicted in an inference phase at the network-side model and indicated in a TCI state switch. Accordingly, the UE uses a fixed Rx beam for the TCI state switch.

In training data collection for the network side model based on MDT framework, the UE reports the gNB beam with corresponding L1-RSRP with a UE Rx beam. During inference, the UE reports the L1-RSRP and corresponding network beam index (CRI/SSBRI, may be more than 4) assuming the UE Rx beam. It is noted that the UE Rx beam at training and inference phase may be different.

According to some example embodiments, a UE capability is defined for the use of fixed Rx beam during a P2 inference procedure when the UE previously determined the Rx beam in a P2 procedure, e.g., according to the fourth case discussed above for UE beam implementation for a network-side model. When the UE supports this capability, and when AI-based BM is used for the P2 procedure, after SSB beam sweeping, when the TCI state of set B beam is QCLed to root SSB, the TCI state is known when the following is met: the target TCI state is based on RS from set A beams and the measurement in set B beams are both with QCL relationship configured to a root SSB beam (e.g., set A beam 1−>SSB1, set B beam 2−>SSB1); the time between TCI state switch command and transmission of the QCLed SSB shall not exceed X ms, e.g., X=1280 ms (legacy); the UE shall send measurement report for the QCLed RS from Set B between transmission and TCI state switch; and the TCI state and SSB of TCI state remain detectable during TCI state switching period. Otherwise, the TCI state is unknown.

In an alternative embodiment, when the UE capability for using the fixed Rx beam (as above) is supported and reported to the network, the TCI state is always known if the UE sends a measurement report from Set B between transmission and TCI state switch. The rationale is the Rx beam is known already (a fixed Rx beam for Set B beams is applied to all set A beams)

For a UE-side model, the network-side beam information is either completely unknown, or signaled by association ID based on current RAN1 discussion. An association ID may be used to abstract the network beams, but not the beam information (e.g., beam width, angle, etc.). When the association ID is signaled by the network, the UE model implementation for determining the UE Rx beam may be assumed according to the following two cases.

In a first case, the UE performs joint Tx/Rx beam pair prediction by the UE-side AI model. The best Tx beam may be reported to the network and the best Rx beam is for UE internal usage (e.g., is not part of the feedback information to the network).

In the data collaboration procedure at the UE side for set A and set B measurement, the network may sweep the Set A beams and the Set B beams. The association ID between set A and set B is required. Accordingly, during training, the UE may determine a best Rx beam per Tx beam and use this information as ground truth labeling for the training data. During inference, the UE measures the L1-RSRP based on set B measurement and the inference output is the best Tx/Rx beam pair. The UE performs inference to derive the best DL beam and feedback the corresponding SSBID and CSIRSID. The UE then uses the best UE Rx beam for the set A beam reception. Optionally, the UE may feedback the corresponding QCL root to the gNB.

In a second case, the UE performs Tx beam prediction by the UE-side AI model based on a best UE Rx beam. In other words, the input to the AI model is only the Tx beam measurements and the output is only the predicted Tx beam. In this case, the UE may build a QCL mapping table between the Set A beams and the Set B beams based on the association ID.

In the data collaboration procedure at the UE side for set A and set B measurement, the network sweeps the Set A beams and the Set B beams. The association ID between set A and set B is required. The UE builds a QCL mapping table of UE Rx beam, mapping set A and set B beam QCL relationship itself per associate ID. During inference, the UE measures the L1-RSRP based on set B configuration using the best UE Rx beam (best UE Rx beam based on beam sweeping of set B RS transmission). The UE performs inference to derive the best DL beam and feedback the corresponding SSBID and CSIRS-ID. The UE derives the best UE Rx beam based on the QCL mapping for this particular association ID. Optionally, the UE feeds back the corresponding QCL root to the gNB.

According to some example embodiments, a UE capability is defined for supporting Rx beam determination for Set A without a Set A measurement during inference, e.g., according to either the first case or the second case discussed above for UE Rx beam implementation for a UE-side model. Additionally, a UE functionality is defined for supporting the UE capability per association ID.

FIG. 6 shows a signaling diagram 600 for UE capability and adaptability signaling for AI/ML beam management according to various example embodiments. The signaling diagram 600 includes a UE 601 and the network 602. In 605, the UE receives from the network a capability inquiry (UECapabilityEnquiry). In 610, the UE reports capability information (UECapabilityInformation). In 615, the UE receives a configuration for AI/ML BM using a UE side model (in RRCReconfiguration). In 620, the UE reports functionality information (in Applicable functionality Reporting). In 625, the UE receives a configuration for AI/ML BM using the UE side model (in RRCReconfiguration). In 630, operations such as activation, deactivation, inference and monitoring may be performed for the AI/ML model.

In one embodiment, referring to step 610 above, the UE capability reporting may indicate the UE may perform Rx beam determination for Set A without Set A measurement during inference. In another embodiment, referring to step 620 above, the UE functionality reporting may indicate the UE capability per association ID.

In one embodiment, if the network does not indicate a QCL type D relationship of set A and set B beams, and if the UE indicates the capability and applicability discussed above, the TCI state is known when the following is met: the time between the TCI state switch command and transmission of the set B RS shall not exceed X ms (e.g., X=1280 ms (legacy) or X=1280 ms+inference time for set A); the UE shall send inference report for Set A between Set B transmission and TCI state switch; the target TCI state is part of the inference report of Set A; and the TCI state and SSB of TCI state remain detectable during TCI state switching period. Otherwise, it is unknown.

In another embodiment, if the network indicates the QCL type D relationship of set A and set B beams, the TCI state is known when the following is met: the time between the TCI state switch command and transmission of the set B RS shall not exceed X ms (e.g., X=1280 ms (legacy) or X=1280 ms+inference time for set A); the UE shall send inference report for Set A between Set B transmission and TCI state switch; the target TCI state is part of the inference report of Set A; and the TCI state and SSB of TCI state remain detectable during TCI state switching period. Otherwise, it is unknown.

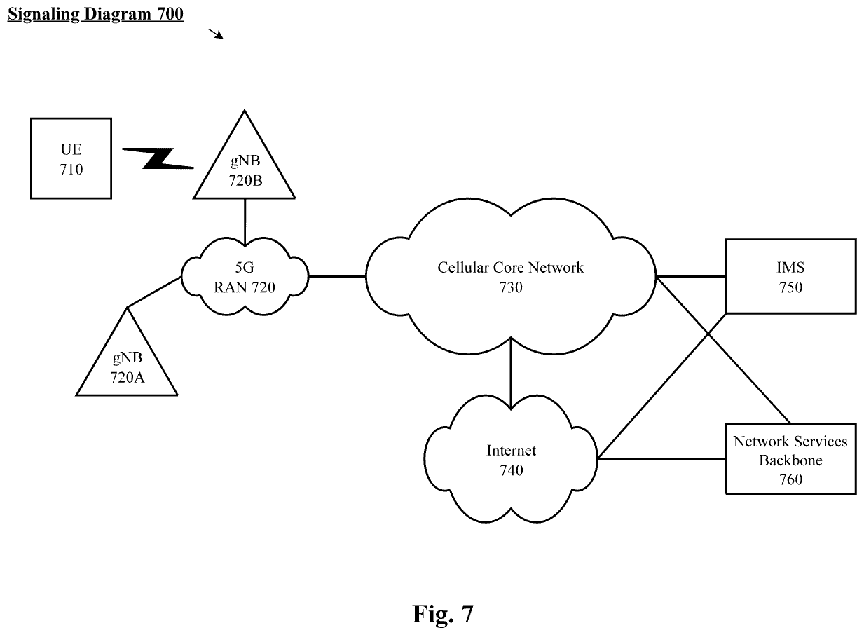

FIG. 7 shows an example network arrangement 700 according to various example embodiments. The example network arrangement 700 includes a UE 710. The UE 710 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 710 is merely provided for illustrative purposes.

The UE 710 may be configured to communicate with one or more networks. In the example of the network arrangement 700, the network with which the UE 710 may wirelessly communicate is a 5G NR radio access network (RAN) 720. However, the UE 710 may also communicate with other types of networks (e.g., 5G cloud RAN, a next generation RAN (NG-RAN), a legacy cellular network, etc.) and the UE 710 may also communicate with networks over a wired connection. With regard to the example embodiments, the UE 710 may establish a connection with the 5G NR RAN 720. Therefore, the UE 710 may have a 5G NR chipset to communicate with the NR RAN 720.

The 5G NR RAN 720 may be portions of a cellular network that may be deployed by a network carrier (e.g., Verizon, AT&T, T-Mobile, etc.). The RAN 720 may include cells or base stations that are configured to send and receive traffic from UEs that are equipped with the appropriate cellular chip set. In this example, the 5G NR RAN 720 includes the gNB 720A and the gNB 720B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 710 to connect to the 5G NR RAN 720. For example, as discussed above, the 5G NR RAN 720 may be associated with a particular network carrier where the UE 710 and/or the user thereof has a contract and credential information (e.g., stored on a SIM card). Upon detecting the presence of the 5G NR RAN 720, the UE 710 may transmit the corresponding credential information to associate with the 5G NR RAN 720. More specifically, the UE 710 may associate with a specific cell (e.g., gNB 720A).

The network arrangement 700 also includes a cellular core network 730, the Internet 740, an IP Multimedia Subsystem (IMS) 750, and a network services backbone 760. The cellular core network 730 manages the traffic that flows between the cellular network and the Internet 740. The IMS 750 may be generally described as an architecture for delivering multimedia services to the UE 710 using the IP protocol. The IMS 750 may communicate with the cellular core network 730 and the Internet 740 to provide the multimedia services to the UE 710. The network services backbone 760 is in communication either directly or indirectly with the Internet 740 and the cellular core network 730. The network services backbone 760 may be generally described as a set of components (e.g., servers, network storage arrangements, etc.) that implement a suite of services that may be used to extend the functionalities of the UE 710 in communication with the various networks.

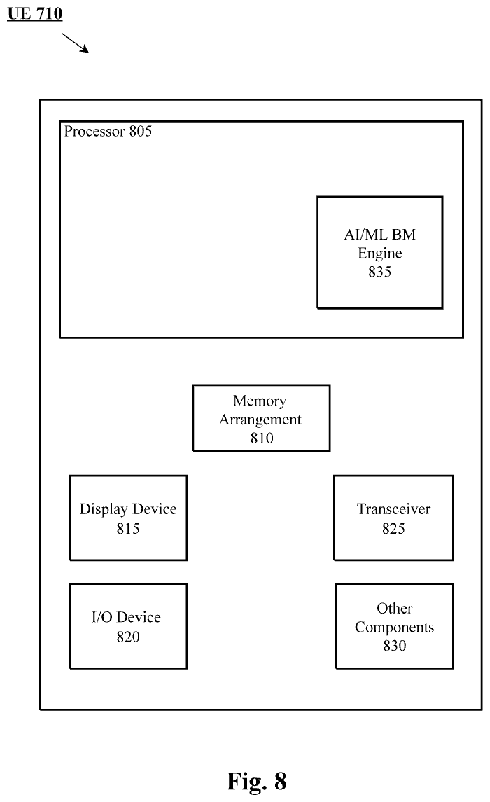

FIG. 8 shows an example UE 710 according to various example embodiments. The UE 710 will be described with regard to the network arrangement 700 of FIG. 7. The UE 710 may represent any electronic device and may include a processor 805, a memory arrangement 810, a display device 815, an input/output (I/O) device 820, a transceiver 825, and other components 830. The other components 830 may include, for example, an audio input device, an audio output device, a battery that provides a limited power supply, a data acquisition device, ports to electrically connect the UE 710 to other electronic devices, sensors to detect conditions of the UE 710, etc.

The processor 805 may be configured to execute a plurality of engines for the UE 710. For example, the engines may include an AI/ML BM engine 835 for performing operations related to performing a TCI state switch when an AI/ML model is employed for beam prediction, as described in detail above.

In some examples, beam measurement inputs may be fed to the AI/ML BM engine 835. The AI/ML BM engine 835 may include one or more learning-based and/or non-learning-based models for perceiving, synthesizing, and inferring information. The AI/ML BM engine 835 may include any suitable number of processes to predict a beam in the spatial or temporal domain based on input beam measurement data.

Persons of ordinary skill in the art will appreciate that the AI/ML BM engine 835 may include any suitable machine learning models that are well-known or widely available such as regression techniques, classification techniques, neural networks, and deep learning networks. In instances where the AI/ML BM engine 835 comprises a machine-learning based model, the AI/ML BM engine 835 may be trained to predict a beam based on beam measurement data using one or more well-known or widely available training techniques such as supervised learning, semi-supervised learning, unsupervised learning, and/or reinforcement learning techniques. The training data may include the aforementioned beam measurement data.

The above referenced engine being an application (e.g., a program) executed by the processor 805 is only an example. The functionality associated with the engines may also be represented as a separate incorporated component of the UE 710 or may be a modular component coupled to the UE 710, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 805 is split among two or more processors such as a baseband processor and an applications processor. The example embodiments may be implemented in any of these or other configurations of a UE.

The memory arrangement 810 may be a hardware component configured to store data related to operations performed by the UE 710. The display device 815 may be a hardware component configured to show data to a user while the I/O device 820 may be a hardware component that enables the user to enter inputs. The display device 815 and the I/O device 820 may be separate components or integrated together such as a touchscreen.

The transceiver 825 may be a hardware component configured to establish a connection with the 5G NR-RAN 720, an LTE-RAN (not pictured), a legacy RAN (not pictured), a WLAN (not pictured), etc. Accordingly, the transceiver 825 may operate on a variety of different frequencies or channels (e.g., set of consecutive frequencies). The transceiver 825 includes circuitry configured to transmit and/or receive signals (e.g., control signals, data signals). Such signals may be encoded with information implementing any one of the methods described herein. The processor 805 may be operably coupled to the transceiver 825 and configured to receive from and/or transmit signals to the transceiver 825. The processor 805 may be configured to encode, decode and/or process signals (e.g., signaling from a base station of a network) for implementing any one of the methods described herein.

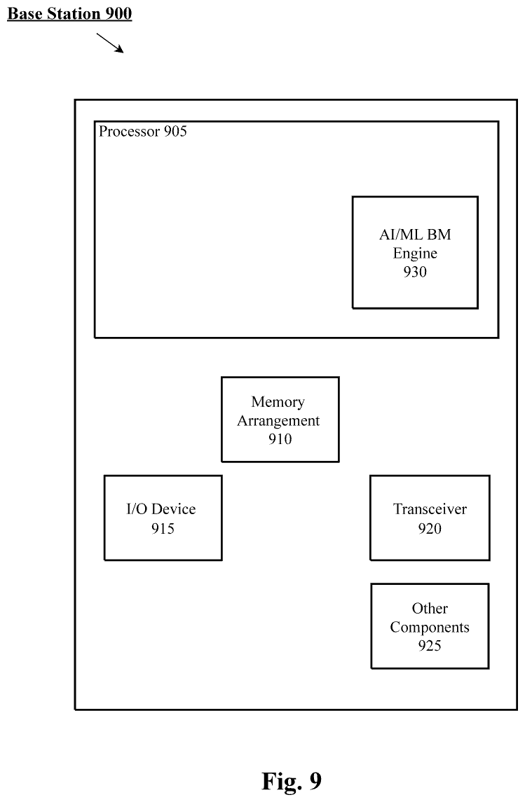

FIG. 9 shows an example base station 900 according to various example embodiments. The base station 900 may represent the gNB 720A, the gNB 720B or any other access node through which the UE 710 may establish a connection and manage network operations. The base station 900 may operate as the MN or the SN as described in the examples above.

The base station 900 may include a processor 905, a memory arrangement 910, an input/output (I/O) device 915, a transceiver 920, and other components 925. The other components 925 may include, for example, an audio input device, an audio output device, a battery, a data acquisition device, ports to electrically connect the base station 500 to other electronic devices and/or power sources, etc.

The processor 905 may be configured to execute a plurality of engines for the UE 710. For example, the engines may include an AI/ML BM engine 930 for performing operations related to performing a TCI state switch when an AI/ML model is employed for beam prediction, as described in detail above.

In some examples, beam measurement inputs may be fed to the AI/ML BM engine 930. The AI/ML BM engine 930 may include one or more learning-based and/or non-learning-based models for perceiving, synthesizing, and inferring information. The AI/ML BM engine 930 may include any suitable number of processes to predict a beam in the spatial or temporal domain based on input beam measurement data.

Persons of ordinary skill in the art will appreciate that the AI/ML BM engine 930 may include any suitable machine learning models that are well-known or widely available such as regression techniques, classification techniques, neural networks, and deep learning networks. In instances where the AI/ML BM engine 930 comprises a machine-learning based model, the AI/ML BM engine 930 may be trained to predict a beam based on beam measurement data using one or more well-known or widely available training techniques such as supervised learning, semi-supervised learning, unsupervised learning, and/or reinforcement learning techniques. The training data may include the aforementioned beam measurement data.

The memory arrangement 910 may be a hardware component configured to store data related to operations performed by the base station 900. The I/O device 915 may be a hardware component or ports that enable a user to interact with the base station 900.

The transceiver 920 may be a hardware component configured to exchange data with the UE 710 and any other UE in the network arrangement 700. The transceiver 920 may operate on a variety of different frequencies or channels (e.g., set of consecutive frequencies). The transceiver 920 includes circuitry configured to transmit and/or receive signals (e.g., control signals, data signals). Such signals may be encoded with information implementing any one of the methods described herein. The processor 905 may be operably coupled to the transceiver 920 and configured to receive from and/or transmit signals to the transceiver 920. The processor 905 may be configured to encode, decode and/or process signals (e.g., signaling from a UE) for implementing any one of the methods described herein.

### EXAMPLES

In a first example, a method, comprising measuring, based on signaling from a network, a first set of reference signals (RS) for a first set of beams, generating, for transmission to the network, a measurement report corresponding to the first set of beams, wherein second measurements for a second set of beams are predicted from first measurements of the first set of RS and processing, based on signaling from the network, a command to switch an active transmission configuration indicator (TCI) state to a target TCI state associated with the second set of beams, the target TCI state having a known condition when the apparatus supports a capability for determining a best receive (Rx) beam to use for the second set of beams, the target TCI state having an unknown condition when the apparatus does not support the capability.

In a second example, the method of the first example, wherein the first set of beams comprises Set B beams used as input to an artificial intelligence (AI) model for beam management implemented by the network and the second set of beams comprises Set A beams output by the AI model.

In a third example, the method of the second example, wherein the capability comprises always determining the best Rx beam to use for any target TCI state associated with the Set A beams.

In a fourth example, the method of the third example, further comprising, during a training phase for the AI model, measuring, based on signaling from the network, the Set A beams and the Set B beams and reporting, to the network, the best Rx beam for the Set A beams, wherein, in an inference phase for the AI model, the first measurements of the first set of RS included in the measurement report are assumed to be measured with the best Rx beam.

In a fifth example, the method of the fourth example, further comprising, during the training phase for the AI model, storing the best Rx beam in global coordinates and, during the inference phase for the AI model, determining the best Rx beam based on sensor information.

In a sixth example, one or more processors configured to perform any of the methods of the first through fifth examples.

In a seventh example, a user equipment (UE) configured to perform any of the methods of the first through fifth examples.

In an eighth example, a method, comprising processing, based on signaling from a network, one or more quasi-co-location (QCL) relationships between a first set of reference signal (RS) for a first set of beams and a second set of RS for a second set of beams, measuring, based on signaling from a network, the first set of RS for the first set of beams, generating, for transmission to the network, a measurement report corresponding to the first set of beams, wherein second measurements for a second set of beams are predicted from first measurements of the first set of RS and processing, based on signaling from the network, a command to switch an active transmission configuration indicator (TCI) state to a target TCI state associated with the second set of beams, the target TCI state having a known condition when the target TCI state is based on RS from the second set of beams with a QCL relationship configured to RS from the first set of beams.

In a ninth example, the method of the eighth example, wherein the first set of beams comprises Set B beams used as input to an artificial intelligence (AI) model for beam management implemented by the network and the second set of beams comprises Set A beams output by the AI model.

In a tenth example, the method of the ninth example, further comprising, during a training phase for the AI model, measuring, based on signaling from the network, the Set B beams and set A beams and reporting, to the network, the L1-RSRP for the Set B beams using its corresponding best Rx beam, and the L1-RSRP for the set A beams, using the Rx beam corresponding to the QCLed set B beam, wherein, in an inference phase for the AI model, the first measurements of the first set of RS included in the measurement report are assumed to be measured with the best Rx beam.

In an eleventh example, the method of the ninth example, wherein the one or more QCL relationships between the first set of RS and the second set of RS is signaled in a training phase for the AI model or in an inference phase for the AI model.

In a twelfth example, the method of the ninth example, wherein the target TCI state has the known condition when the command is received within a predetermined duration from a time at which the first set of RS were transmitted.

In a thirteenth example, the method of the twelfth example, wherein the predetermined duration is equal to 1280 ms.

In a fourteenth example, one or more processors configured to perform any of the methods of the eighth through thirteenth examples.

In a fifteenth example, a user equipment (UE) configured to perform any of the methods of the eighth through thirteenth examples.

In a sixteenth example, a method, comprising measuring, based on signaling from a network, a first set of reference signal (RS) for a first set of beams, generating, for transmission to the network, a measurement report corresponding to the first set of beams, wherein second measurements for a second set of beams are predicted from first measurements of the first set of RS and processing, based on signaling from the network, a command to switch an active transmission configuration indicator (TCI) state to a target TCI state associated with the second set of beams, the target TCI state having an unknown condition when the apparatus supports a capability for using a fixed or beam for measuring the second set of beams.

In a seventeenth example, the method of the sixteenth example, wherein the first set of beams comprises Set B beams used as input to an artificial intelligence (AI) model for beam management implemented by the network and the second set of beams comprises Set A beams output by the AI model.

In an eighteenth example, one or more processors configured to perform any of the methods of the sixteenth through seventeenth examples.

In a nineteenth example, a user equipment (UE) configured to perform any of the methods of the sixteenth through seventeenth examples.

In a twentieth example, a method, comprising, measuring, based on signaling from a network, a first set of reference signal (RS) for a first set of beams, generating, for transmission to the network, a measurement report corresponding to the first set of beams, wherein second measurements for a second set of beams are predicted from first measurements of the first set of RS and processing, based on signaling from the network, a command to switch an active transmission configuration indicator (TCI) state to a target TCI state associated with the second set of beams, the target TCI state having a known condition when the apparatus supports a capability for determining a fixed receive (Rx) beam to use for the second set of beams based on measurements acquired during a P2 beam management procedure.

In a twenty first example, the method of the twentieth example, wherein the first set of beams comprises Set B beams used as input to an artificial intelligence (AI) model for beam management implemented by the network and the second set of beams comprises Set A beams output by the AI model.

In a twenty second example, the method of the twenty first example, wherein the target TCI state has the known condition when the target TCI state is based on RS from the Set A beams and both the Set A beams and the Set B beams have a QCL relationship configured to a root synchronization signal block (SSB).

In a twenty third example, the method of the twenty second example, wherein the target TCI state has the known condition when the command is received within a predetermined duration from a time at which the first set of RS were transmitted.

In a twenty fourth example, the method of the twenty third example, wherein the predetermined duration is equal to 1280 ms.

In a twenty fifth example, the method of the twentieth example, wherein the target TCI state is always known when the apparatus supports the capability.

In a twenty sixth example, one or more processors configured to perform any of the methods of the twentieth through twenty fifth examples.

In a twenty seventh example, a user equipment (UE) configured to perform any of the methods of the twentieth through twenty fifth examples.

In a twenty eighth example, a method, comprising measuring, based on signaling from a network, a first set of reference signals (RS) from a first set of beams, predicting, from a first set of reference signal measurements for the first set of RS, second reference signal measurements for a second set of beams, generating, for transmission to the network, a measurement report corresponding to the second set of beams and processing, based on signaling from the network, a command to switch an active transmission configuration indicator (TCI) state to a target TCI state associated with the second set of beams, the target TCI state having a known condition when the apparatus supports a capability for determining a receive (Rx) beam to use for the second set of beams and further supports a functionality for determining the Rx beam to use for the second set of beams based on an association identifier (ID) between the first set of beams and the second set of beams.

In a twenty ninth example, the method of the twenty eighth example, wherein the first set of beams comprises Set B beams used as input to an artificial intelligence (AI) model for beam management implemented by the apparatus and the second set of beams comprises Set A beams output by the AI model.

In a thirtieth example, the method of the twenty ninth example, further comprising processing, based on signaling from the network, the association ID.

In a thirty first example, the method of the twenty eighth example, further comprising reporting the capability in capability signaling and reporting the functionality in adaptability signaling.

In a thirty second example, the method of the twenty eighth example, wherein the TCI state has the known condition when a quasi-co-location (QCL) type D relationship between the Set A beams and the Set B beams is not signaled by the network.

In a thirty third example, the method of the twenty eighth example, wherein the TCI state has the known condition when the command is received within a predetermined duration from a time at which the first set of RS were transmitted.

In a thirty fourth example, the method of the thirty third example, wherein the predetermined duration is 1280 ms.

In a thirty fifth example, the method of the thirty third example, wherein the predetermined duration is a sum of 1280 ms and a time for predicting the Set A beams in an inference phase.

In a thirty sixth example, the method of the twenty ninth example, wherein the AI model is configured for joint transmit (Tx) beam and Rx beam pair prediction.

In a thirty seventh example, the method of the thirty sixth example, further comprising feeding back a best Tx beam to the network and using a best Rx beam for Set A beam reception.

In a thirty eighth example, the method of the thirty seventh example, further comprising feeding back a quasi-co-location (QCL) root corresponding to the best Tx beam to the network.

In a thirty ninth example, the method of the twenty ninth example, wherein the AI model is configured for best transmit (Tx) beam prediction based on a best receive (Rx) beam.

In a fortieth example, the method of the thirty ninth example, further comprising, during a training phase for the AI model, building a quasi-co-location (QCL) mapping table of QCL relationships between Set A beams and Set B beams per association ID.

In a forty first example, the method of the fortieth example, further comprising, during an inference phase for the AI model, deriving the best Rx beam based on the QCL mapping table.

In a forty second example, one or more processors configured to perform any of the methods of the twenty eighth through forty first examples.

In a forty third example, a user equipment (UE) configured to perform any of the methods of the twenty eighth through forty first examples.

In a forty fourth example, a method, comprising measuring, based on signaling from a network, a first set of reference signals (RS) from a first set of beams, predicting, from a first set of reference signal measurements for the first set of RS, second reference signal measurements for a second set of beams, generating, for transmission to the network, a measurement report corresponding to the second set of beams and processing, based on signaling from the network, a command to switch an active transmission configuration indicator (TCI) state to a target TCI state associated with the second set of beams, the target TCI state having a known condition when the apparatus previously processed, based on signaling from the network, one or more quasi-co-location (QCL) relationships between the first set of RS and the second set of RS.

In a forty fifth example, the method of the forty fourth example, wherein the first set of beams comprises Set B beams used as input to an artificial intelligence (AI) model for beam management implemented by the apparatus and the second set of beams comprises Set A beams output by the AI model.

In a forty sixth example, the method of the forty fifth example, wherein the TCI state has the known condition when the command is received within a predetermined duration from a time at which the first set of RS were transmitted.

In a forty seventh example, the method of the forty sixth example, wherein the predetermined duration is 1280 ms.

In a forty eighth example, the method of the forty sixth example, wherein the predetermined duration is a sum of 1280 ms and a time for predicting the Set A beams in an inference phase.

In a forty ninth example, one or more processors configured to perform any of the methods of the forty fourth through forty eighth examples.

In a fiftieth example, a user equipment (UE) configured to perform any of the methods of the forty fourth through forty eighth examples.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

Some embodiments described herein may include use of learning and/or non-learning-based process(es). The use may include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML beam management processes may be used to benefit users.

For example, the data may be used to train models that may be deployed to improve performance, accuracy, and/or functionality of applications and/or services. Accordingly, the use of the data enables the AI/ML beam management processes to adapt and/or optimize operations to provide more personalized, efficient, and/or enhanced user experiences. Such adaptation and/or optimization may include tailoring content, recommendations, and/or interactions to individual users, as well as streamlining processes, and/or enabling more intuitive interfaces. Further beneficial uses of the data in the AI/ML beam management processes are also contemplated by the present disclosure.

The present disclosure contemplates that, in some embodiments, data used by AI/ML beam management processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML beam management processes, should attempt to comply with well-established privacy policies and/or privacy practices.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
measure, based on signaling from a network, a first set of reference signals (RS) for a first set of beams;
generate, for transmission to the network, a measurement report corresponding to the first set of beams, wherein second measurements for a second set of beams are predicted from first measurements of the first set of RS; and
process, based on signaling from the network, a command to switch an active transmission configuration indicator (TCI) state to a target TCI state associated with the second set of beams, the target TCI state having a known condition when the apparatus supports a capability for determining a best receive (Rx) beam to use for the second set of beams, the target TCI state having an unknown condition when the apparatus does not support the capability.

2. The apparatus of claim 1, wherein the first set of beams comprises Set B beams used as input to an artificial intelligence (AI) model for beam management implemented by the network and the second set of beams comprises Set A beams output by the AI model.

3. The apparatus of claim 2, wherein the capability comprises always determining the best Rx beam to use for any target TCI state associated with the Set A beams.

4. The apparatus of claim 3, wherein the processing circuitry is further configured to:
during a training phase for the AI model, measure, based on signaling from the network, the Set A beams and the Set B beams; and
report, to the network, the best Rx beam for the Set A beams,
wherein, in an inference phase for the AI model, the first measurements of the first set of RS included in the measurement report are assumed to be measured with the best Rx beam.

5. The apparatus of claim 4, wherein the processing circuitry is further configured to:
during the training phase for the AI model, store the best Rx beam in global coordinates; and
during the inference phase for the AI model, determine the best Rx beam based on sensor information.

6. An apparatus comprising processing circuitry configured to:
process, based on signaling from a network, one or more quasi-co-location (QCL) relationships between a first set of reference signal (RS) for a first set of beams and a second set of RS for a second set of beams;
measure, based on signaling from a network, the first set of RS for the first set of beams;
generate, for transmission to the network, a measurement report corresponding to the first set of beams, wherein second measurements for a second set of beams are predicted from first measurements of the first set of RS; and
process, based on signaling from the network, a command to switch an active transmission configuration indicator (TCI) state to a target TCI state associated with the second set of beams, the target TCI state having a known condition when the target TCI state is based on RS from the second set of beams with a QCL relationship configured to RS from the first set of beams.

7. The apparatus of claim 6, wherein the first set of beams comprises Set B beams used as input to an artificial intelligence (AI) model for beam management implemented by the network and the second set of beams comprises Set A beams output by the AI model.

8. The apparatus of claim 7, wherein the processing circuitry is further configured to:
during a training phase for the AI model, measure, based on signaling from the network, the Set B beams and set A beams; and
report, to the network, the L1-RSRP for the Set B beams using its corresponding best Rx beam, and the L1-RSRP for the set A beams, using the Rx beam corresponding to the QCLed set B beam,
wherein, in an inference phase for the AI model, the first measurements of the first set of RS included in the measurement report are assumed to be measured with the best Rx beam.

9. The apparatus of claim 7, wherein the one or more QCL relationships between the first set of RS and the second set of RS is signaled in a training phase for the AI model or in an inference phase for the AI model.

10. The apparatus of claim 7, wherein the target TCI state has the known condition when the command is received within a predetermined duration from a time at which the first set of RS were transmitted.

11. The apparatus of claim 10, wherein the predetermined duration is equal to 1280 ms.

12. An apparatus comprising processing circuitry configured to:
measure, based on signaling from a network, a first set of reference signal (RS) for a first set of beams;
generate, for transmission to the network, a measurement report corresponding to the first set of beams, wherein second measurements for a second set of beams are predicted from first measurements of the first set of RS; and
process, based on signaling from the network, a command to switch an active transmission configuration indicator (TCI) state to a target TCI state associated with the second set of beams, the target TCI state having a known condition when the apparatus supports a capability for determining a fixed receive (Rx) beam to use for the second set of beams based on measurements acquired during a P2 beam management procedure.

13. The apparatus of claim 12, wherein the first set of beams comprises Set B beams used as input to an artificial intelligence (AI) model for beam management implemented by the network and the second set of beams comprises Set A beams output by the AI model.

14. The apparatus of claim 12, wherein the target TCI state has the known condition when the target TCI state is based on RS from the Set A beams and both the Set A beams and the Set B beams have a QCL relationship configured to a root synchronization signal block (SSB).

15. The apparatus of claim 14, wherein the target TCI state has the known condition when the command is received within a predetermined duration from a time at which the first set of RS were transmitted.

16. The apparatus of claim 15, wherein the predetermined duration is equal to 1280 ms.

17. The apparatus of claim 12, wherein the target TCI state is always known when the apparatus supports the capability.
